(19) United States
(12) Patent Application Publication
(10) Pub. No.: US 2018/0088800 A1
(43) Pub. Date: Mar. 29, 2018

(54) METHOD FOR SELECTING AN ELEMENT FROM AMONG A GROUP OF ELEMENTS DISPLAYABLE ON A SMALL INPUT SURFACE

(71) Applicant: Eric PROVOST, Châtillon (FR)

(72) Inventor: Eric PROVOST, Châtillon (FR)

(21) Appl. No.: 15/563,192

(22) PCT Filed: Mar. 30, 2016
(86) PCT No.: PCT/FR2016/000061

§ 371 Date: Sep. 29, 2017

(30) Foreign Application Priority Data
Apr. 2, 2015 (FR) 1500673

(51) Int. Cl. G06F 3/0488; G06F 3/0482; G06F 3/0484

(52) U.S. Cl. CPC G06F 3/04886; G06F 3/0482; G06F 2203/04807; G06F 2203/04804; G06F 3/04845

(57) ABSTRACT

Method for selecting an element from among a group of elements displayable on a small input surface.

The invention relates to a man-machine interface method using apparatuses having a small input surface of the portable telephone type, connected watch or digital tablet. It consists of a means of selecting an element, from a group of elements. The invention makes it possible to input characters of the alphabet but also any other items, ideograms, symbols, actions. For this purpose, the proposed invention uses a screen, a device for locating at least one contact on this screen and a pointing device such as a finger or a stylus. The invention makes it possible to reduce input errors related to the promiscuity of the elements of the usual methods of input of the virtual keyboard type by increasing the size of the areas to be pointed at. The invention does not make it necessary to learn a way of inputting an element beyond the basic principle of pointing and moving this pointer. The invention allows on average faster input of the elements than a multiplicity of presses on an area. The invention requires only a small input surface. The system defines the use of a magnification-reduction pair, of overlaying, of an input reminder aiding the user in the use thereof. The invention can be located as a function of the applications and languages used.

### CONTEXT

This invention relates to a method of selecting elements from among a group of elements displayable on a small input surface such as mobile phone, connected watch or digital tablet. The method makes it possible to input characters of the alphabet but also any other items, ideograms or actions.

It is common to use a virtual keyboard for the inputting of characters which on small screens creates the problem of the promiscuity of the virtual keys inducing incorrect input or requiring the use of a stylus and the user's special attention in order to select a character. The other usual way is to group together in the form of a ten-key keyboard the letters of the alphabet and by successive presses on these keys to choose the expected character. This latter method requires the user's time and dexterity from the user namely synchronising a number of key presses in a defined time. Finally input systems based on the recognition of shapes more or less require learning the shapes that can be recognised by the device for each letter.

This invention has for object to overcome the problems mentioned hereinabove.

To this effect, the invention proposes a method of selecting elements from among a group of elements according to claim 1.

Advantageously, the method according to the invention makes it possible to push back the limits of the screen sizes required to that of a watch to carry out an input, and provides among other things the advantage of limiting the user's dexterity necessary for carrying out an input.

The method according to the invention can also comprise one or several of the characteristics hereinbelow, considered individually or according to any technically permissible combinations:
if the pointing instrument makes contact with the screen outside of an input area, slides over several validation areas, then preferably the first or the last pointed validation area when the pointing instrument points to a central area or breaks the contact with the screen will be considered as the validation area chosen and validated and the chosen input area being the input area that includes the chosen validation area, moreover if the pointing instrument makes contact with the screen in a validation area then the input area with which it is associated is the chosen input area and the pointed validation area is the chosen validation area; and/or
the pointing instrument makes contact with the screen in the validation area, then slides over other validation areas before entering a central area or breaking the contact with the screen, then the elements and groups of elements or optionally only the content of the first input area are used as information that can be used for the element contained in the last validation area, considered as the validation area chosen and validated, during the evaluation of the latter with as the chosen input area the input area that includes the chosen validation area; and/or
the central area of an input area can optionally contain an element or a list of elements that can be selected successively indexed by passing through zero called the list, the selecting followed by the evaluation is carried out via a simple press then releasing the pointing instrument on this central area if the element is a single element or that at the index zero of the list, if the pointing instrument makes contact with the screen in the validation area, called primary validation area, or was in the central area then slides into a validation area, then called validation primary, then slides over an adjacent validation area in the dextrorotatory or levorotatory direction of the same input area that contains the central area that contains the list, then the index associated with the central area is incremented by one or respectively decremented by one if this incrementation or decrementation produces an index of the list and these index incrementation or decrementation operations continue as long as the pointing instrument passes through the validation areas of the same input area and when the pointing instrument enters a central area or breaks its contact with the screen, the element corresponding to the index of the list in the central area is evaluated as a single element, the evaluation of the single element is done with a chosen input area being the input area that contains the central area that contains the list, in the same way, whether or not the central area contains one element or elements, if the primary validation area contains a dynamic command: which has the ability to be evaluated at each incrementation or decrementation of the index in order to transmit this change to a remote target application or not of the system, then regardless of the minimum and maximum values that the index can have, as soon as the pointing instrument points firstly, or after having pointed a central area, a primary validation area containing a dynamic command, at each passage from a validation area to another of the same input area, in the dextrorotatory or levorotatory direction, the command is evaluated with as a parameter respectively an incrementation or a decrementation until the return in the central area of the pointing instrument or the break of contact with the screen, the dynamic command of the primary validation area which is then considered as the chosen validation area and validated is then evaluated as a single element with a finalisation parameter, the chosen input area is the input area associated with the chosen validation area; and/or
the input area pointed to in the central area thereof will in a configurable way magnify the size thereof on the screen in such a way that the other input areas are always able to be pointed in their central area and the magnified input area always fully visible, this magnification can favour the magnification of the validation areas by shrinking the central area of the magnified input area, until the break of the contact or the validation of a validation area by pointing of a central area this magnification is maintained, then returns to its original size; and/or
the magnification of an input area can with configuration push back the other input areas on the edge of the screen or impose a decrease that can be configured of the size of the other input areas substantially of their peripheral area in such a way as to always be pointed in their central area, at the end of the magnification of the input area, the other input areas return to their original positions and sizes, when the input area reduces its size around the central area, the validation areas therefore reduce their size in a configurable way and possibly to a size of zero; and/or
the magnification of an input area can be configured in such a way as to offset the centre thereof and makes it possible to always have on the screen the other input areas that can be pointed in their central area, thus making it possible to magnify at most the input area over the entire screen while still leaving it entirely readable; and/or
the display of the input areas can be done as an overlay of an application that requires input, this overlay can have an adjustable transparency or contrasted colours with respect to the covered screen image; and/or
the display of the invention outside of its use referred to as standby can with configuration be limited to a maximum in order to leave readable a possible application that requires an input whereon the invention will be displayed as an overlay, for example simply leaving a practically transparent mask that recalls the display of the central areas; and/or
characterised in that with configuration, it allows to appear the validation areas that are graphically reduced to a maximum in order to leave the user with the possibility of using the validation areas at the first contact of the pointing instrument, for example let visible only the contour of the validation areas and leave a hole in place of the central area, this standby display is reactivated as soon as the invention has not been used for a period of time that can be configured; and/or
the display of the method of selecting elements from among a group of elements is characterised on the configuration by a first magnifying phase of all of the validation or opacification areas of the appearance of the input areas during the beginning of input on the central area and in a second phase, during the path of the pointing instrument of the magnification described hereinabove of the input area; and/or
when the pointing instrument passes over a validation area that can be validated, its appearance changes in such a way as to identify the future validation area selected, all of the other validation areas of the same input area have an identical appearance, in the case of a possible pointing of several validation areas, the validation areas known as able to be used by the commands displayed in the validation areas can retain a dedicated appearance, as soon as a validated validation area appears all of the validation areas return to their appearance at the activation of the invention; and/or
during the choice of a validation area, when the validation areas of the reduced input areas remain visible and when the future item selected is a group of elements, then the input area closest to the validation area that contains this selected future item can change the content of its validation areas with respect to the group of elements and return to its original appearance in the case where the pointing instrument changes validation area; and/or
the evaluation of the selected element can be transmitted to peripheral devices connected by a wireless link (for example of the IEEE 802.15, IEEE 802.11, etc. type) or physical of the series link type (for example of the USB, RS232, etc. type); and/or
an area dedicated to input return for validation of the user is filled using a copy of the result of the evaluation of the selected element ; and/or
the distribution of the elements and groups of elements on the validation areas is done according to the languages by favouring the most commonly used letters, symbols and actions in the form of single elements in the validation areas of the input areas preferably separated from the other input areas at the activation of the invention and the least used in the form of groups of elements in the validation areas of the input areas adjacent to another input area at the activation of the invention; and/or
the character elements can be placed at the activation of the invention on the contour of the input areas, in the validation areas that do not have a selection area in the immediate vicinity in alphabetical order relegating the last letters of the alphabet if necessary in a validation area adjacent to a selection area in the form of a group of elements; and/or
the elements for the selection of ideograms can begin with a group of elements representing the number of lines used in the ideogram in order to correspond to the dictionary; and/or
the elements for the selection of ideograms can symbolise the first line drawn that would correspond to groups of elements representing the second line which itself is comprised of groups of elements of the third line if it exists and so on until the input of the element that corresponds to the ideogram.

### DESCRIPTION OF THE DRAWINGS

The invention shall be understood better when reading the following description provided by way of a non-limiting example of the implementation of it, and when examining the annexed figures wherein:

FIG. 1: example of an input area.

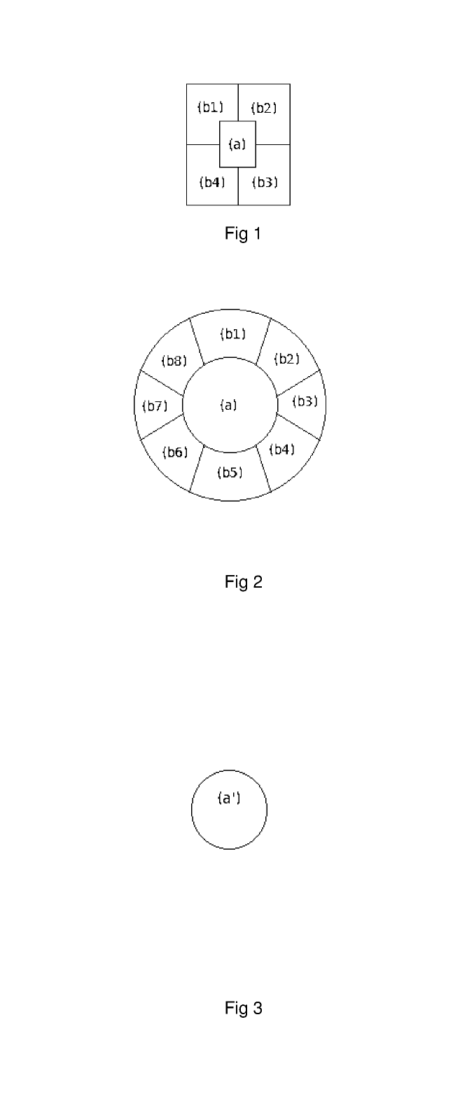

Key: (a) input area for commands
(bx) input areas for characters

FIG. 2: example of an input area on a screen

Key: (a) central area of the input area
(bx) validation areas associated with the input area

FIG. 3: example of reducing the size of the input areas

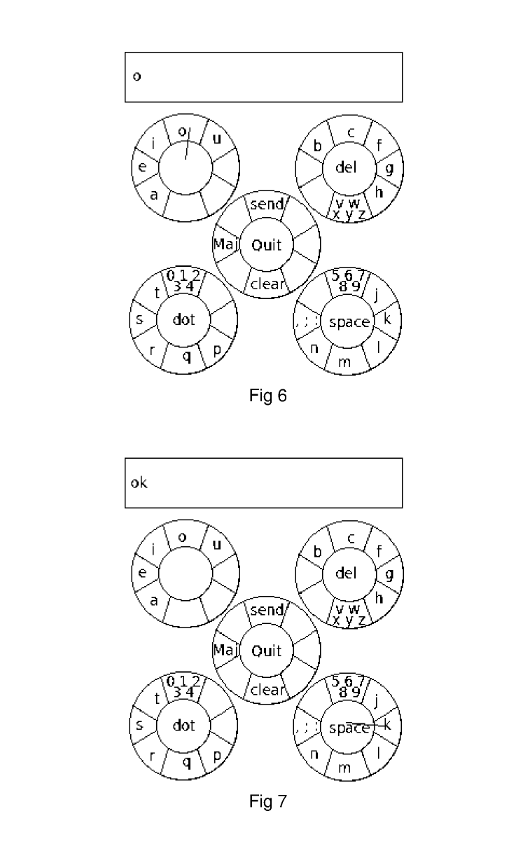

Key: (a′) central area of the reduced input area

FIG. 4: example of a magnified input area.

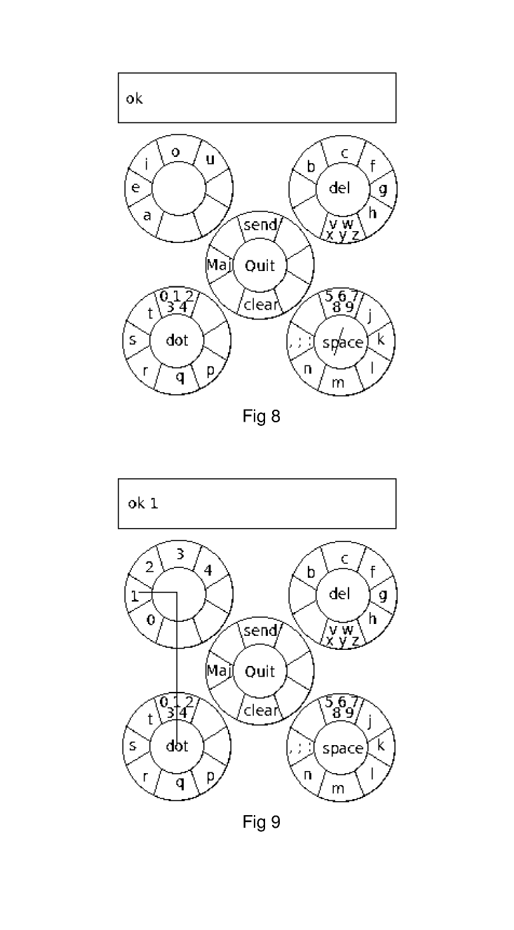

Key: (a′) central area of the magnified input area
(bx′) validation areas associated with the magnified input area

FIG. 5: example of input without magnification, step 0

FIG. 6: example of input without magnification, step 1

FIG. 7: example of input without magnification, step 2

FIG. 8: example of input without magnification, step 3

FIG. 9: example of input without magnification, step 4

FIG. 10: example of input with magnification, step 4

FIG. 11: example of the distribution of elements with separate input areas

FIG. 12: example of an input system at an input area.

FIG. 13: Input of a central area command at the index 1: here configuration of the elements as unlocked capitals. The black line is the path of the pointing instrument with a large circle for its position at the end of the line.

FIG. 14 to 29: Step of inputting the text “Bonjour” and sending. The black line is the displacement of the pointing instrument with a large circle for its position at the end of the line at the end of the step.

### DEFINITIONS

Element: entity having a graphical representation and being able to be input, it is the object of the input. Examples: a letter of the alphabet, a menu item, etc.

Group of elements: set or subset of elements that can be input.

Pointing instrument: tool allowing for the beginning and the end of the input of a location on the screen that changes over time.

Examples: a press, displacement and lifting of a finger on a capacitive screen, a stylus on a resistive screen, a mouse click on a computer screen.

Input area: it is subdivided into two areas: one central area strictly surrounded by the other peripheral area. It can be of any shape but for the example will be circular in this disclosure.

Central area: central area of the input area receiving the beginning and the end of the input by the pointing instrument. It can be of any shape but for the example will be circular in this disclosure.

Validation area: segmentation of the peripheral area of the input area that represents the elements or groups of elements that can be input. It can be of any shape but for the example in this disclosure will be a part of a circular ring segmented into 8 parts.

Input: An input begins primarily in the central area by a press within of the pointing instrument and is completed with the stopping of the press at any location of the screen. The input can begin at any location other than a central area, which in this case requires a special processing.

Selected item: element or group of elements represented by the last validation area passed through by the pointing instrument over the input area that last had its central area passed through by the input instrument.

Activation of the invention: instant when the graphical representation of the invention appears for the first time on the screen after an interruption of its use. It corresponds to a reference configuration referred to as the basic configuration.

Input return area: area that provides a monitoring of previously input elements that are not actions.

Example: characters, items, ideograms, etc.

Training configuration: configuration of the invention in such a way that its usage requires a minimum of training.

### Disclosure

The invention is integrated into a hardware solution or a device that has a screen aligned on a position sensor and a pointer. A processor and memory pair handles the processing of the position information of the pointer and the treating of it as the pointing instrument: these elements make it possible to determine a character or a command to be input. According to the availabilities of the hardware solution, the transmission of the input can take place over a wired or wireless link with another device, at each letter or command input or by batch of text input on the hardware solution.

The method of selecting elements from among a group of elements displayable on a screen of a small input surface of a mobile terminal (such as mobile phone, connected watch or touchpad) is characterised in that it comprises a system for displaying and for pointing and displayable areas referred to as input which are composed of two parts, one strictly included in the other: the first is central, referred to as central area used as a starting and validation point during the pointing thereof, the second is peripheral entirely surrounding the central area, divided into subparts such that each part has at most only two others of these adjacent parts and that these parts are all close to the central area and can be selected exclusively singularly by pointing, they are referred to as validation areas and contain the elements or the groups of elements to be selected; and in that it comprises the following steps:
Activating the invention: there is a distribution of input areas on the screen and assigning of elements or group of elements to the input areas according to a predefined basic configuration.
Choosing an input area by pointing to its central area: the pointing instrument makes contact with the screen on the central area.
Choosing a validation area of the chosen input area by pointing: the pointing instrument slides from the central area to a validation area.
Validating the last validation area chosen is then said to be validated by pointing to a central area always by sliding the pointing instrument. If the pointed central area is outside of the chosen input area, the other validation areas remain transparent—as nonexistent—to the pointing instrument.
If the validated validation area contained a group of elements, then this group of elements is divided and distributed over the validation areas of the input area that was last pointed to in the central area. Except for the input area pointed to in the central area, all of the other input areas return to the basic configuration at the activation of the invention. Then there is a continuation of the input at the step of choosing a validation area if the pointing instrument is still in contact with the screen by using the last input area pointed to as the chosen input area.
If the validated validation area contained a single element, then this element is evaluated for action or character input. All of the input areas return to their basic configuration at the activation of the invention. Then there is a continuation of the input at the step of choosing a validation area if the pointing instrument is still in contact with the screen by using the last input area pointed to as the chosen input area. A new element can then be input without lifting the pointing instrument.
During the break of the contact with the screen of the pointing instrument, if no validation area has been chosen by pointing nothing is selected; if a validation area containing a single element has been chosen by pointing then this element is evaluated for action or input; if a validation area containing a group of elements has been chosen by pointing then this group of elements is divided and distributed over the validation areas of the chosen input area for a duration that can be configured or if the duration has not elapsed and the pointing instrument has resumed contact with the screen until the break of the contact or validation of a validation area by pointing to a central area. At the end of contact break management all of the input areas return to their basic configuration.

Evaluating the element refers to transmitting a character or a command to an application via a wired or wireless connection or mechanism for exchanging in memory or any other means. Note that the target application of the evaluation of the element can be the manager for associating elements or groups of elements with validation areas with the purpose of reorganising them. This reorganisation is by example the functionality of the shift key of a typewriter.

As such pointing to a central area of an input area selects the possible validation areas (exclusively that of the pointed input area) and once the choice of the validation area has been made, it is validated by joining one of the central areas available on the screen after having left the input area that was originally pointed to.

This method of selecting elements from among a group of elements is characterised in that if the pointing instrument makes contact with the screen outside an input area, slides over several validation areas, then preferably the first or the last validation area pointed to when the pointing instrument points to a central area or breaks the contact with the screen will be considered as the validation area chosen and validated and the chosen input area is the input area including the chosen validation area. Moreover if the pointing instrument makes contact with the screen in a validation area then the input area with which it is associated is the chosen input area and the pointed validation area is the chosen validation area. As the validation is carried out as described hereinabove, input areas can be done as an overlay of an application that requires input, this overlay can have an adjustable transparency or contrasted colours with respect to the covered screen image.

This method of selecting elements from among a group of elements is characterised in that if the pointing instrument makes contact with the screen in the validation area, then slides over other validation areas before entering a central area, then the elements and groups of elements or optionally only the content of the first input area are used as parameters for the element contained in the last validation area, considered as the validation area chosen and validated, during the evaluation of this element with as the chosen input area the input area that includes the chosen validation area.

This method of selecting elements from among a group of elements is characterised in that the central area of an input area can optionally contain an element or a list of elements that can be selected indexed successively by passing through zero called the list. The selection followed by the evaluation is carried out via a simple press then releasing the pointing instrument on this central area if the element is a single element or that at the index zero of the list. If the pointing instrument makes contact with the screen in the validation area, called primary validation area, or was in the central area then slides into a validation area, then called validation primary, then slides over an adjacent validation area in the dextrorotatory or levorotatory direction of the same input area which contains the central area containing the list, then the index associated with the central area is incremented by one or respectively decremented by one if this incrementation or decrementation produces an index of the list and these index incrementation or decrementation operations continue as long as the pointing instrument passes through the validation areas of the same input area and when the pointing instrument enters the central area or breaks its contact with the screen, the element corresponding to the index of the list in the central area is evaluated as being a single element. The evaluation of the single element is carried out with a chosen input area being the input area that contains the central area containing the list. In the same way, whether or not the central area contains one of the elements, if the primary validation area contains a dynamic command: which has the ability to be evaluated at each incrementation or decrementation of the index in order to transmit this change to a remote target application or not of the system, then regardless of the minimum and maximum values that the index can have, as soon as the pointing instrument points firstly, or after having pointed a central area, a primary validation area containing a dynamic command, at each passage from a validation area to another of the same input area, in the dextrorotatory or levorotatory direction, the command is evaluated with as a parameter respectively an incrementation or a decrementation until the return in the central area of the pointing instrument or the break of contact with the screen, the dynamic command of the primary validation area which is then considered as the validation area chosen and validated is then evaluated as a single element with a finalisation parameter, the chosen input area is the input area associated with the chosen validation area.

Among the useful command elements, the neutral command or command without effect is possible or a command that counts the simple presses then the immediate and successive releasing of the pointing instrument in the central area in order to simulate a double press on a key, also that of changing the default configuration of the validation areas, finally commands that have an effect only for a period of time or a certain number of element evaluations. Note that retaining at least one central area free of elements that can be selected or that have as a first element a neutral command allows for a globally opaque and magnified display of the invention (first display phase following the beginning of an input).

This method of selecting elements from among a group of elements is characterised in that the input area pointed to in its central area will in a configurable way magnify the size thereof on the screen in such a way that the other input areas are always able to be pointed in their central area and the magnified input area always fully visible. This magnification can favour the magnification of the validation areas by shrinking the central area of the magnified input area. Until the break of the contact or validation of a validation area by the pointing of a central area this magnification is maintained, then returns to its original size.

In addition the method of selecting elements from among a group of elements is characterised in that the magnification of an input area can push back the other input areas on the edge of the screen or impose a reduction in the size of the other input areas substantially of their peripheral area in such a way as to always be able to be pointed in their central area. At the end of the magnification of the input area, the other input areas return to their original positions and sizes. When the input area reduces its size around the central area, the validation areas therefore reduce their size in a configurable way and possibly to a size of zero.

Also this method of selecting elements from among a group of elements is characterised in that the magnification of an input area can be configured in such a way as to offset the centre thereof and makes it possible to always have on the screen the other input areas that can be pointed in their central area. This then makes it possible to magnify at most the input area on the entire screen while still leaving it entirely readable.

The display of the method of selecting elements from among a group of elements is characterised in that the display of the input areas can be done as an overlay of an application that requires input. This overlay can have an adjustable transparency or contrasted colours with respect to the covered screen image.

The display of the method of selecting elements from among a group of elements is characterised in that the display of the invention outside of its use referred to as standby can be limited to a maximum in order to leave readable a possible application that requires input whereon the invention will be displayed as an overlay. For example simply leaving a practically transparent mask that recalls the display of the central areas. Inversely, it may be necessary to allow to appear the validation areas graphically reduced to a maximum in order to leave the user with the possibility of using the validation areas at the first contact of the pointing instrument. For example leave as visible only the contour of the validation areas and leave a hole in place of the central area. This standby display is reactivated as soon as the invention has not been used for a period of time that can be configured.

The magnified display of the method of selecting elements from among a group of elements is characterised on the setting by a first magnifying phase of all of the validation or opacification areas of the appearance of the input areas during the beginning of the input on the central area and in a second phase, during the displacement of the pointing instrument of the magnification described hereinabove of the input area.

The graphical representation of the invention is not necessarily perpetually present on the screen of the input device and can be activated. Example of input of the pointing instrument at the centre of the screen ending immediately.

During the activation of the invention the input areas are distributed over the entire surface area of the screen dedicated to the input. They are displayed as an overlay that is more or less opaque over the preceding display. They have sizes that can be configured which in the training configuration allows for a reading of the content of the elements of the validation areas.

When the pointing instrument passes over a validation area that can be validated, the appearance thereof changes in such a way as to identify the future validation area selected. All of the other validation areas of the same input area have an identical appearance. Example: a video inversion or a change in the background colour for the validation area of the future item selected and another background colour for the other validation areas. In the case of a possible pointing of several validation areas, the validation areas known as able to be used by the commands displayed in the validation areas can retain a dedicated appearance. As soon as a validated validation area appears all of the validation areas return to their appearance at the activation of the invention.

The method of selecting elements from among a group of elements is characterised in that optionally, during the choice of a validation area, when the validation areas of reduced input areas remain visible and the future selected item is a group of elements, then the input area closest to the validation area containing this future selected item can change the content of the validation areas thereof with respect to the group of elements and return to its original appearance in the case where the pointing instrument change of validation area.

The method of selecting elements from among a group of elements is characterised in that the evaluation of the selected element can be transmitted to any type of peripheral device connected by a wireless link (for example of the IEEE 802.15, IEEE 802.11, etc. type) or physical link of the serial link type (for example of the USB, RS232, etc. type). As such the invention makes it possible to control a connected peripheral device or act as the keyboard for a connected television for example or simple universal remote control.

The method of selecting elements from among a group of elements is characterised in that an area dedicated to the input return for validation of the user is filled using a copy of the result of the evaluation of the selected element.

The method of selecting elements from among a group of elements displayable is characterised in that the distribution of the elements and groups of elements on the validation areas is done according to the languages by favouring the most commonly used letters, symbols and actions in the form of single elements in the validation areas of the input areas that are preferably separated from the other input areas at the activation of the invention and the least used in the form of groups of elements in the validation areas of the input areas next to another input area at the activation of the invention.

The character elements can be placed at the activation of the invention on the contour of the input areas, in the validation areas that do not have a selection area in the immediate vicinity in alphabetical order relegating the last letters of the alphabet if necessary in a validation area close to a selection area in the form of a group of elements.

The method of selecting elements from among a group of elements is characterised in that optionally a line following the pointing instrument can be plotted which allows the user to follow the change in their input.

The elements for the selection of ideograms can begin with a group of elements representing the number of lines used in the ideogram in order to correspond to the dictionary.

The elements for the selection of ideograms can symbolise the first line drawn that could correspond to groups of elements representing the second line which themselves are comprised of groups of elements of the third line if it exists and so on until the input of the element corresponding to the ideogram.

For reasons of practicality, it can be possible to create groups of input areas that have no interaction between them; such as input with two pointing instruments.

### Description of Two Examples

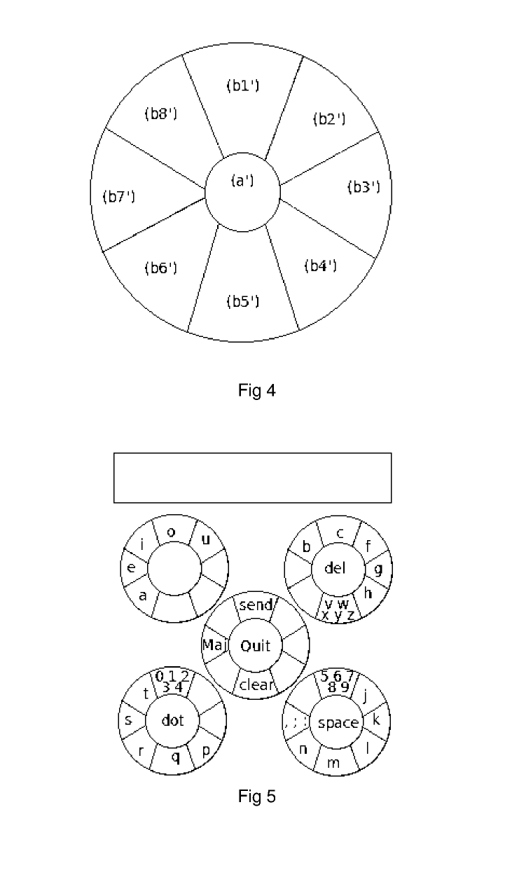

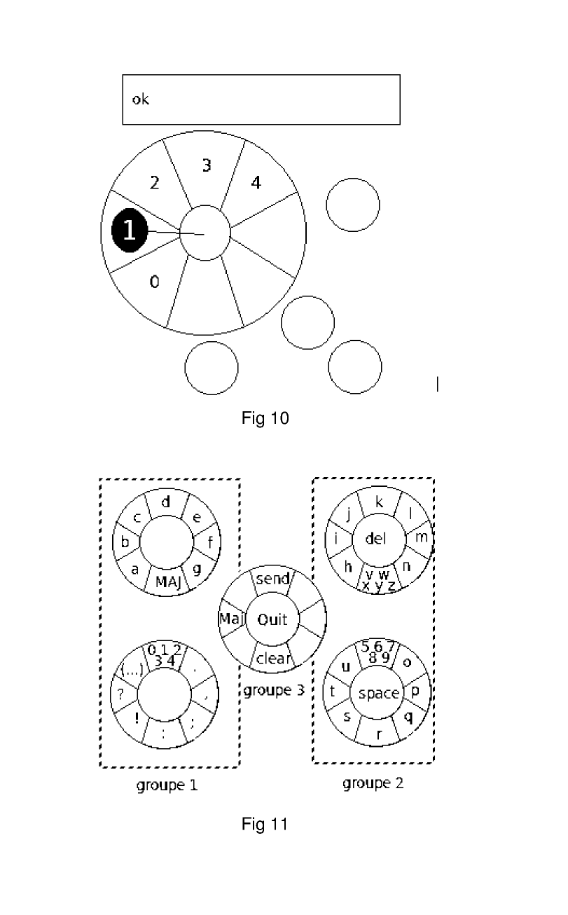

As an example consider 5 input areas comprised of 8 validation areas such as shown in the example of FIG. 2. The distribution of the input areas is done in the shape of a square, with the latest input area located in the middle of the 4 others that occupy the angles of a square as shown in FIG. 5. Inputting the message “ok 1” is carried out as follows: the letters o and k are unique elements associated with a validation area, the space is associated with a central area as for the ‘1’ it is part of the activation of the invention of a group of elements ‘01234’. FIG. 5 shows the invention at the activation thereof.

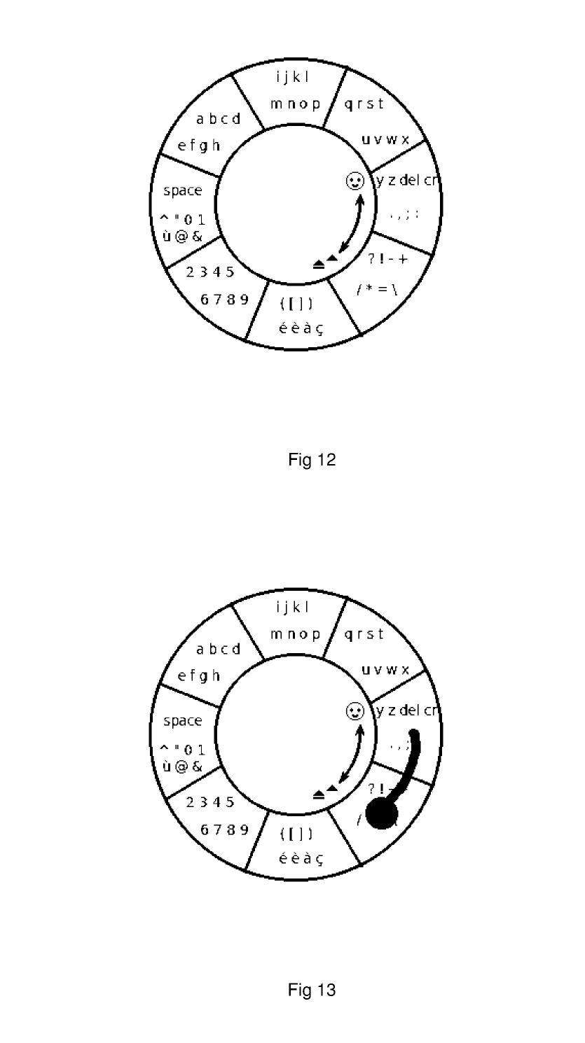

As such, the pointing instrument points to the central area of the input area containing the validation area having the ‘o’ and carries out a displacement until the validation area containing the ‘o’. At the release of the instrument the ‘o’ is input in the input return area. A line in FIG. 6 shows this example.

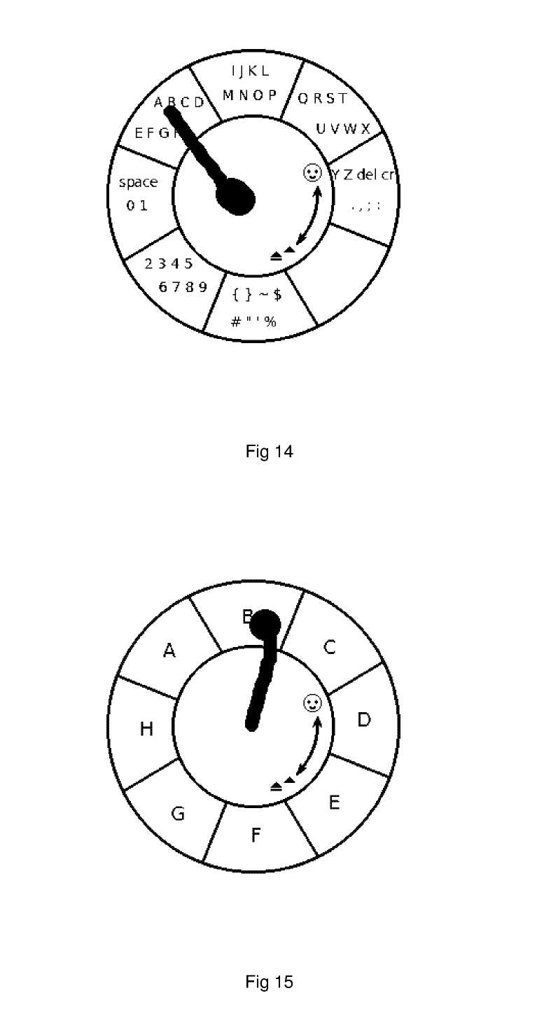

Likewise for the input of the ‘k’. A line in FIG. 7 shows this example.

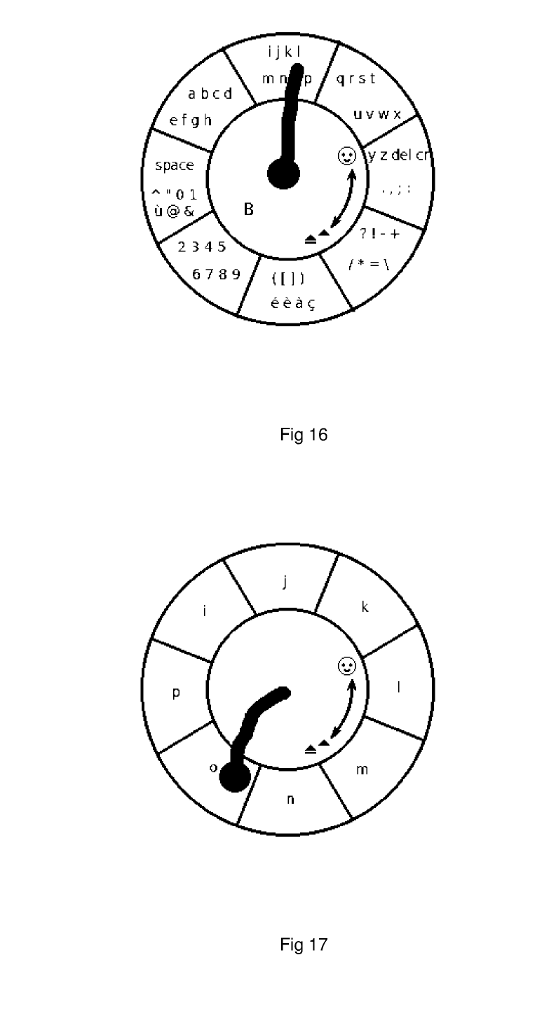

The pointing instrument carries out a simple touch then is removed in the central area acting as a space. The space is therefore input. A line in FIG. 8 shows this example.

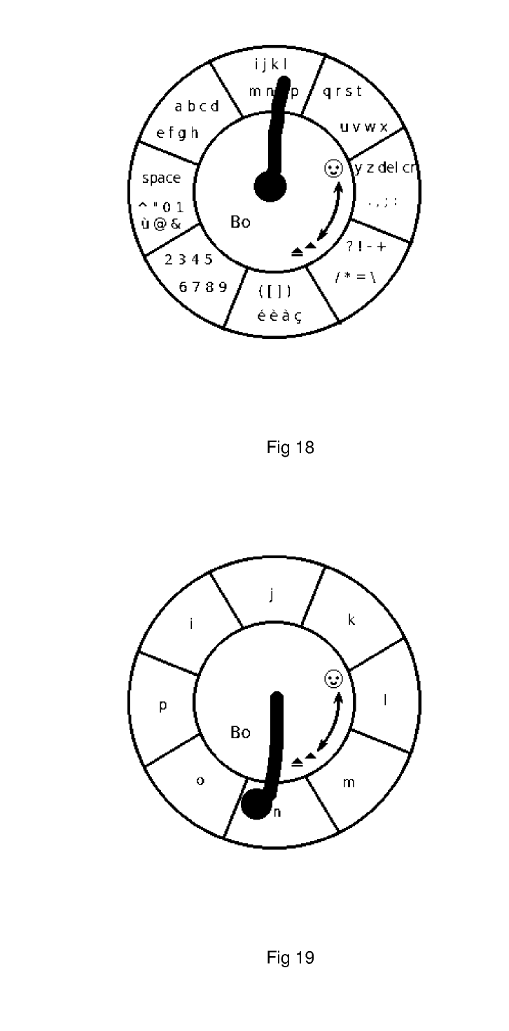

The pointing instrument points to the central area of the input area containing the validation area that has the group of elements ‘01234’ and carries out a displacement until the validation area containing the ‘01234’. Then the pointing instrument continues its path until in the central area of the adjacent input area of which the validation areas have taken for content the elements of the group of elements ‘01234’. As such the pointing instrument will point to the expected ‘1’. At the release of the instrument the ‘1’ is input in the input return area. A line in FIG. 9 shows this example.

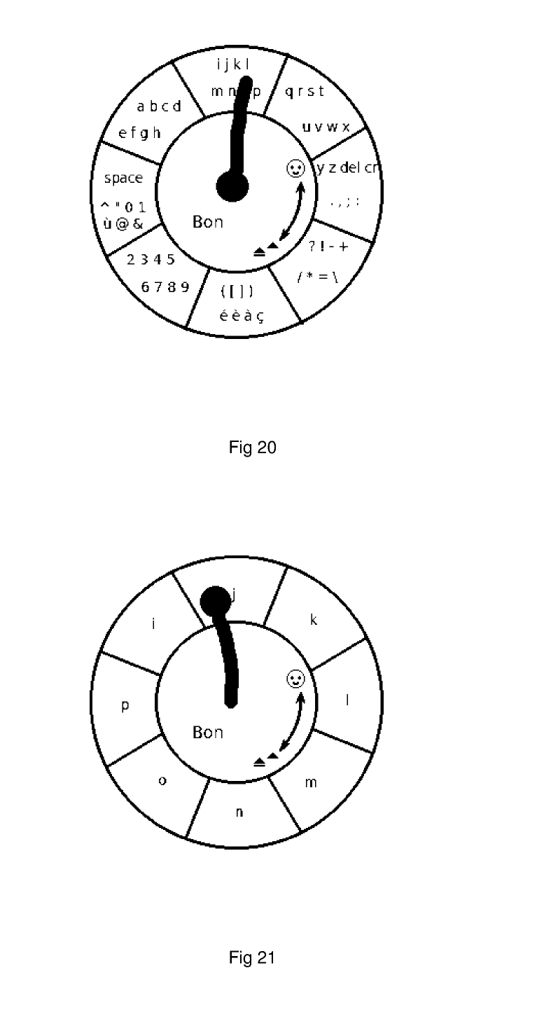

In the case where the magnification factor is not zero, the appearance of the screen before the lifting of the pointing instrument for the inputting of the preceding T is given in FIG. 10.

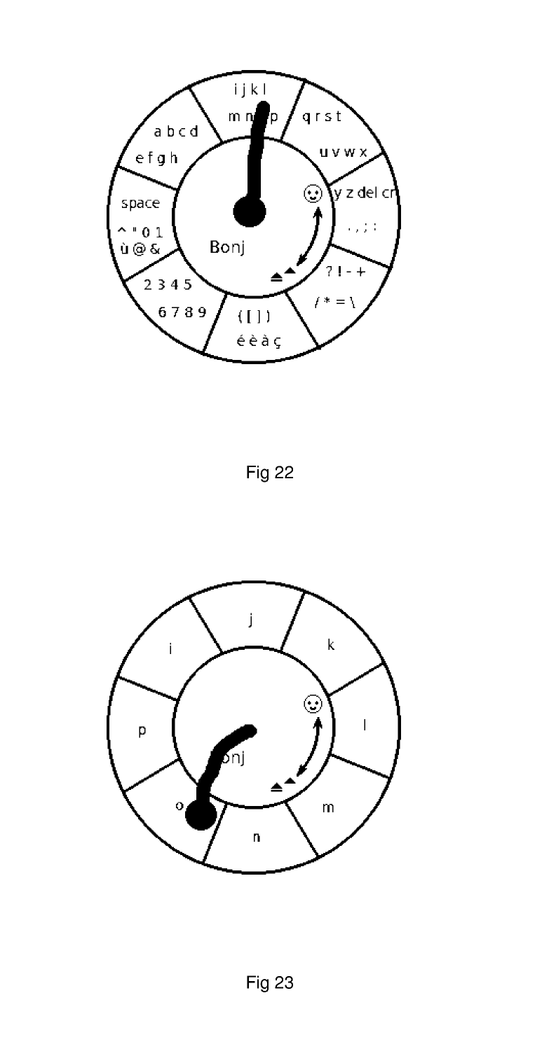

An example of the use of the invention in the case where the input areas can be grouped together is given in FIG. 11. This allows for input with several pointing instruments, ideally with fingers if the size of the screen so allows.

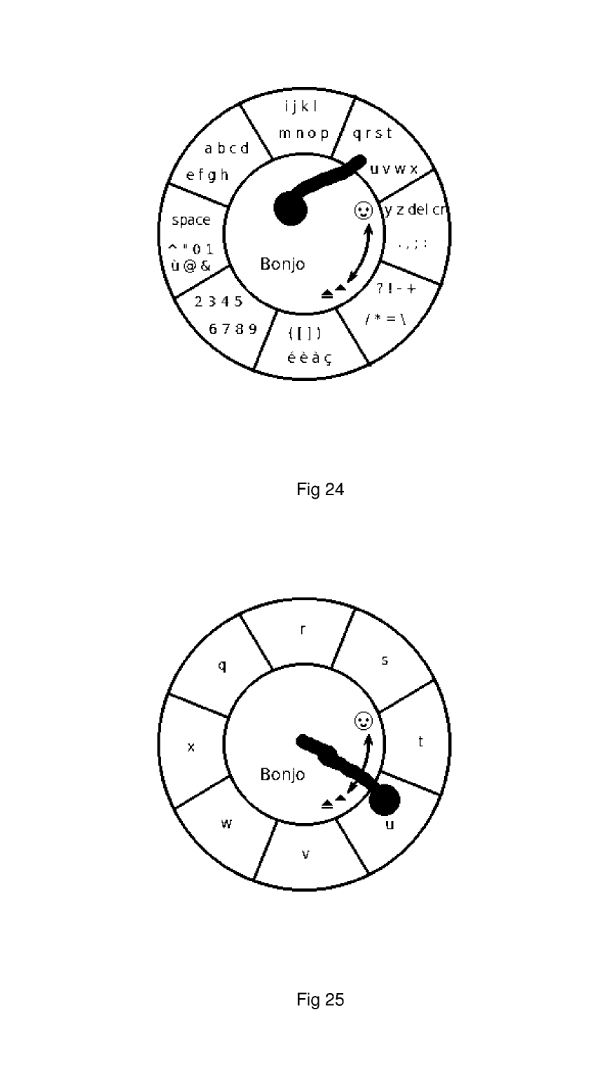

Take for example where input area is considered comprised of 8 validation areas as shown in the example of FIG. 12. The inputting of the message “Bonjour” then the sending thereof to any addressee is done in the following way:

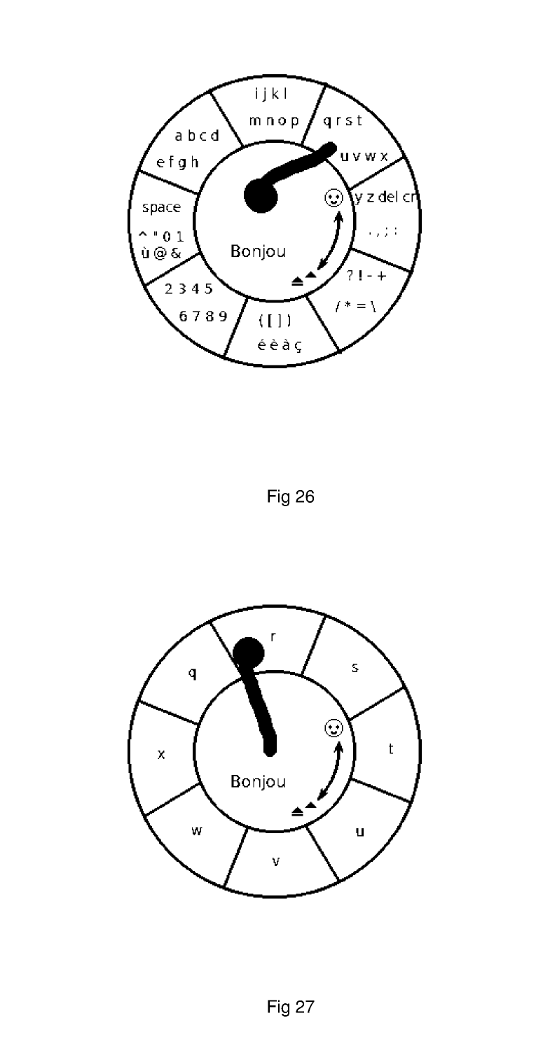

First of all the inputting of the capital B is done by using the command listed in the central area and represented by a simple triangle. The pointing instrument therefore begins its input in a validation area, goes to its validation area immediately in the dextrorotatory direction (FIG. 13) then is displaced in the central area or breaks the contact with the screen. For the next input of a character the elements that can be selected will be capital letters.

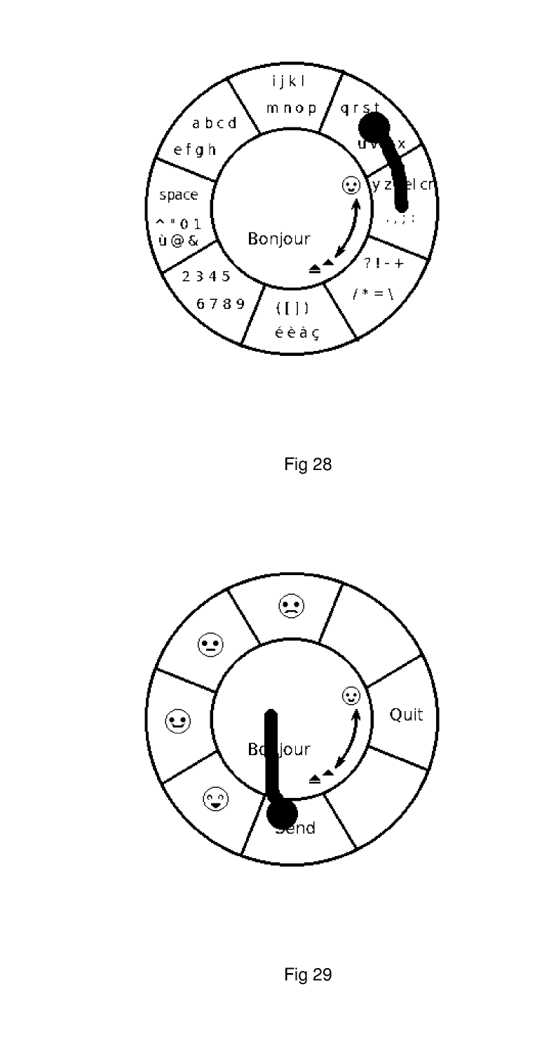

The pointing instrument therefore starts again an input in a validation area [symbol] ABCDEFGH [symbol] is displaced to the central area (FIG. 14) and will then go to the validation area [symbol] B [symbol] then breaks the contact. The element “B” is then input then is transmitted to a hypothetical underlying application. All of the validation areas have their character elements as small letters.

Then the pointing instrument inputs in the same way the characters: ‘o’, ‘n’, ‘j’, ‘o’, ‘u’, ‘r’.

At the end the pointing instrument therefore carries out an input in a validation area, goes to its validation area immediately in the levorotatory direction (FIG. 28) then goes to the central area: the elements of the validation areas become emoticons and commands to be transmitted. Without releasing the contact with the screen the pointing instrument slides over the command “Send” which is transmitted to the underlying application for transmission of the message “Bonjour”.

The method according to the invention is particularly intended for the use of character or action input or through the use of a screen of reduced size such as connected watches or mobile telephones.

The invention is not limited to the particular embodiments that have been described hereinabove, many alternatives can be designed without leaving the scope defined by the attached claims.

1. The terminal comprises a system for displaying and for pointing and one or more displayable areas referred to as input which are composed of two parts, one strictly included in the other: the first is central, referred to as central area used as a starting and as a validation point during the pointing thereof, the second is peripheral fully surrounding the central area, divided into subparts such that each part has at most only two others of these adjacent parts and that these parts are all neighbouring, among other things, very close to the central area and can be selected exclusively unitarily by pointing, they are referred to as validation area and contain the elements or groups of elements to be selected; and in that it comprises the following steps:
Activating the invention: there is a distribution of input areas on the screen and assigning of elements or group of elements to the input areas according to a predefined basic configuration,
Choosing an input area by pointing to its central area: the pointing instrument makes contact with the screen on the central area,
Choosing a validation area of the chosen input area by pointing: the pointing instrument slides from the central area to a validation area,
Validating the last validation area chosen by pointing to a central area always by sliding the pointing instrument, if the pointed central area is outside of the chosen input area, the other validation areas remain transparent—as nonexistent—to the pointing instrument,
If the validated validation area contained a group of elements, then this group of elements is divided and distributed over the validation areas of the input area that was last pointed to in the central area thereof, except for the input area pointed to in the central area thereof, all of the other input areas return to their basic configuration at the activation of the invention, then there is a continuation of the input at the step of choosing a validation area if the pointing instrument is still in contact with the screen by using the last input area pointed to as the chosen input area,
If the validated validation area contained a single element, then this element is evaluated for action: evaluation of a command, or character input, all of the input areas return to their basic configuration at the activation of the invention, then there is a continuation of the input at the step of choosing a validation area if the pointing instrument is still in contact with the screen by using the last input area pointed to as the chosen input area, a new element can then be input without lifting the pointing instrument,
During the break of the contact with the screen of the pointing instrument, if no validation area has been chosen by pointing nothing is selected; if a validation area containing a single element has been chosen by pointing then this element is evaluated for action or input; if a validation area containing a group of elements has been chosen by pointing then this group of elements is divided and distributed over the validation areas of the chosen input area for a duration that can be configured or if the duration has not elapsed and if the pointing instrument has resumed contact with the screen until the break of the contact or validation of a validation area by pointing to a central area, at the end of contact break management all of the input areas return to their basic configuration,
evaluating the element refers to transmitting a character or a command to an application via a wired or wireless connection or mechanism for exchanging in memory, note that the target application of the evaluation of the element can be the manager for associating elements or groups of elements with validation areas for the purpose of reorganising them.

2. Method for selecting elements from among a group of elements according to claim 1 wherein if the pointing instrument makes contact with the screen outside of an input area, slides over several validation areas, then preferably the first or the last pointed validation area when the pointing instrument points to a central area or breaks the contact with the screen will be considered as the validation area chosen and validated and the chosen input area being the input area that includes the chosen validation area, moreover if the pointing instrument makes contact with the screen in a validation area then the input area with which it is associated is the chosen input area and the pointed validation area is the chosen validation area.

3. Method for selecting elements from among a group of elements according to claim 2, wherein the pointing instrument makes contact with the screen in the validation area, then slides over other validation areas before entering a central area or breaking the contact with the screen, then the elements and groups of elements or optionally only the content of the first input area are used as information that can be used for the element contained in the last validation area, considered as the validation area chosen and validated, during the evaluation of the latter with as the chosen input area the input area that includes the chosen validation area.

4. Method for selecting elements from among a group of elements according to claim 3, wherein the central area of an input area can optionally contain an element or a list of elements that can be selected successively indexed by passing through zero called the list, the selecting followed by the evaluation is carried out via a simple press then releasing the pointing instrument on this central area if the element is a single element or that at the index zero of the list, if the pointing instrument makes contact with the screen in the validation area, called primary validation area, or was in the central area then slides into a validation area, then called validation primary, then slides over an adjacent validation area in the dextrorotatory or levorotatory direction of the same input area that contains the central area that contains the list, then the index associated with the central area is incremented by one or respectively decremented by one if this incrementation or decrementation produces an index of the list and these index incrementation or decrementation operations continue as long as the pointing instrument passes through the validation areas of the same input area and when the pointing instrument enters a central area or breaks its contact with the screen, the element corresponding to the index of the list in the central area is evaluated as a single element, the evaluation of the single element is done with a chosen input area being the input area that contains the central area that contains the list, in the same way, whether or not the central area contains one element or elements, if the primary validation area contains a dynamic command: which has the ability to be evaluated at each incrementation or decrementation of the index in order to transmit this change to a remote target application or not of the system, then regardless of the minimum and maximum values that the index can have, as soon as the pointing instrument points firstly, or after having pointed a central area, a primary validation area containing a dynamic command, at each passage from a validation area to another of the same input area, in the dextrorotatory or levorotatory direction, the command is evaluated with as a parameter respectively an incrementation or a decrementation until the return in the central area of the pointing instrument or the break of contact with the screen, the dynamic command of the primary validation area which is then considered as the chosen validation area and validated is then evaluated as a single element with a finalisation parameter, the chosen input area is the input area associated with the chosen validation area.

5. Method for selecting elements from among a group of elements according to claim 1, wherein the input area pointed to in the central area thereof will in a configurable way magnify the size thereof on the screen in such a way that the other input areas are always able to be pointed in their central area and the magnified input area always fully visible, this magnification can favour the magnification of the validation areas by shrinking the central area of the magnified input area, until the break of the contact or the validation of a validation area by pointing of a central area this magnification is maintained, then returns to its original size.

6. Method for selecting elements from among a group of elements according to claim 5 wherein the magnification of an input area can with configuration push back the other input areas on the edge of the screen or impose a decrease that can be configured of the size of the other input areas substantially of their peripheral area in such a way as to always be pointed in their central area, at the end of the magnification of the input area, the other input areas return to their original positions and sizes, when the input area reduces its size around the central area, the validation areas therefore reduce their size in a configurable way and possibly to a size of zero.

7. Method according to claim 5, wherein the magnification of an input area can be configured in such a way as to offset the centre thereof and makes it possible to always have on the screen the other input areas that can be pointed in their central area, thus making it possible to magnify at most the input area over the entire screen while still leaving it entirely readable.

8. Method for selecting elements from among a group of elements according to claim 5, wherein the display of the input areas can be done as an overlay of an application that requires input, this overlay can have an adjustable transparency or contrasted colours with respect to the covered screen image.

9. Method for selecting elements from among a group of elements according to claim 5, wherein the display of the invention outside of its use referred to as standby can with configuration be limited to a maximum in order to leave readable a possible application that requires an input whereon the invention will be displayed as an overlay, for example simply leaving a practically transparent mask that recalls the display of the central areas.

10. Method for selecting elements from among a group of elements according to claim 9, characterised in that with configuration, it allows to appear the validation areas that are graphically reduced to a maximum in order to leave the user with the possibility of using the validation areas at the first contact of the pointing instrument, for example let visible only the contour of the validation areas and leave a hole in place of the central area, this standby display is reactivated as soon as the invention has not been used for a period of time that can be configured.

11. Method for selecting elements from among a group of elements according to claim 8, wherein the display of the method of selecting elements from among a group of elements is characterised on the configuration by a first magnifying phase of all of the validation or opacification areas of the appearance of the input areas during the beginning of input on the central area and in a second phase, during the path of the pointing instrument of the magnification described hereinabove of the input area.

12. Method for selecting elements from among a group of elements according to claim 8, when the pointing instrument passes over a validation area that can be validated, its appearance changes in such a way as to identify the future validation area selected, all of the other validation areas of the same input area have an identical appearance, in the case of a possible pointing of several validation areas, the validation areas known as able to be used by the commands displayed in the validation areas can retain a dedicated appearance, as soon as a validated validation area appears all of the validation areas return to their appearance at the activation of the invention.

13. Method for selecting elements from among a group of elements according to claim 5, wherein during the choice of a validation area, when the validation areas of the reduced input areas remain visible and when the future item selected is a group of elements, then the input area closest to the validation area that contains this selected future item can change the content of its validation areas with respect to the group of elements and return to its original appearance in the case where the pointing instrument changes validation area.

14. Method for selecting elements from among a group of elements according to claim 5, wherein the evaluation of the selected element can be transmitted to peripheral devices connected by a wireless link (for example of the IEEE 802.15, IEEE 802.11, etc. type) or physical of the series link type (for example of the USB, RS232, etc. type).

15. Method for selecting elements from among a group of elements according to claim 5 wherein an area dedicated to input return for validation of the user is filled using a copy of the result of the evaluation of the selected element.

16. Method for selecting elements from among a group of elements displayable according to claim 5 wherein the distribution of the elements and groups of elements on the validation areas is done according to the languages by favouring the most commonly used letters, symbols and actions in the form of single elements in the validation areas of the input areas preferably separated from the other input areas at the activation of the invention and the least used in the form of groups of elements in the validation areas of the input areas adjacent to another input area at the activation of the invention.

17. Method for selecting elements from among a group of elements according to claim 5, wherein the character elements can be placed at the activation of the invention on the contour of the input areas, in the validation areas that do not have a selection area in the immediate vicinity in alphabetical order relegating the last letters of the alphabet if necessary in a validation area adjacent to a selection area in the form of a group of elements.

18. Method for selecting elements from among a group of elements according to claim 16, wherein the elements for the selection of ideograms can begin with a group of elements representing the number of lines used in the ideogram in order to correspond to the dictionary.

19. Method for selecting elements from among a group of elements according to claim 16, wherein the elements for the selection of ideograms can symbolise the first line drawn that would correspond to groups of elements representing the second line which itself is comprised of groups of elements of the third line if it exists and so on until the input of the element that corresponds to the ideogram.
